(19) United States
(12) Patent Application Publication
(10) Pub. No.: US 2008/0296133 A1
(43) Pub. Date: Dec. 4, 2008

(54) Connector

(75) Inventor: Takahiro Ura, Kanagawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: IRISO ELECTRONICS CO., LTD, KANAGAWA (JP)

(21) Appl. No.: 12/095,150

(22) PCT Filed: Jan. 19, 2007
(86) PCT No.: PCT/JP2007/050786

§ 371 Date: May 28, 2008

(30) Foreign Application Priority Data
Feb. 17, 2006 (JP) 2006-041307

(51) Int. Cl. H01H 9/00

(52) U.S. Cl. 200/1 A

(57) ABSTRACT

The present invention provides a connector that can reduce a load generated on a second terminal by elastic deformation of a first terminal. The connector comprises a first movable housing movable relative to a first stationary housing disposed on the side of a first substrate, multiple plug terminals elastically deformed as the first movable housing moves, a second movable housing movable relative to a second stationary housing disposed on the side of a second substrate, and multiple socket terminals that are elastically deformed as the second movable housing moves and that are contacted with the respective plug terminals when the second movable housing is fitted to the first movable housing, and therefore, a load generated on the socket terminals by the elastic deformation of the plug terminals can be reduced. Thus, connection reliability between the socket terminals and the second substrate can be improved.

### BACKGROUND OF THE INVENTION

1. Field of the Invention

The present invention relates to a connector mounted on a print circuit board and the like to be used for electrically connecting a plurality of circuit boards.

2. Description of the Related Art

As this type of connectors, a connector comprising a first fixed housing arranged on the side of one of objects to be connected, a movable housing provided movably with respect to the first fixed housing, a plurality of first terminals formed so that one end side is held by the fixed housing and the other end side is held by the movable housing and the terminal is elastically deformed with movement of the movable housing, a second fixed housing arranged on the side of the other of the objects to be connected and formed fittable to the movable housing, and a plurality of second terminals held by the second fixed housing and brought into contact with the other end side of each of the first terminals when the second fixed housing is fitted to the movable housing is known (See Patent Document 1, for example).

However, with this connector, since each of the second terminals held by the second fixed housing is fixed to the other object to be connected, if the second fixed housing is fitted with the movable housing while each of the first terminals is elastically deformed, a load in the fitting direction is generated in each of the second terminals by a restoring force of each of the first terminals, which might lower connection reliability between each of the second terminals and the other object to be connected.

Patent Document 1: Japanese Patent Publication No. 10-326651

### BRIEF SUMMARY OF THE INVENTION

The present invention was made in view of the above problems and has an object to provide a connector in which the load generated in the second terminal by the elastic deformation of the first terminal can be reduced.

### MEANS FOR SOLVING THE PROBLEMS

In order to achieve the above object, the present invention comprises a first fixed housing arranged on the side of one of objects to be connected, a first movable housing provided movably with respect to the first housing, a plurality of first terminals having one end sides held by the first fixed housing and the other end sides held by the first movable housing and formed to be elastically deformed with movement of the first movable housing, a second fixed housing arranged on the side of the other of the object to be connected, a second movable housing provided movably with respect to the second fixed housing and formed capable of being fitted in the first movable housing, and a plurality of second terminals having one end sides held by the second fixed housing and the other end sides held by the second movable housing, elastically deformed with movement of the second movable housing, and formed so as to be brought into contact with the other end side of each of the first terminals, respectively, when the second movable housing is fitted in the first movable housing.

By this arrangement, according to the elastic deformation of the first terminals, the second terminals in contact with them are elastically deformed, and the load generated in the second terminals by the elastic deformation of the first terminals can be reduced.

### ADVANTAGES OF THE INVENTION

According to the present invention, since the load generated in the second terminal by the elastic deformation of the first terminal can be reduced, connection reliability between the second terminal and the other object to be connected can be improved. Also, since the first and second terminals are elastically deformed, a movable range can be made larger and displacement between the one object to be connected and the other object to be connected is absorbed so as to facilitate electric connection.

### BRIEF DESCRIPTION OF THE DRAWINGS

FIG. 1 is a perspective view of a plug according to an embodiment of the present invention;

FIG. 2 is a plan view of the plug;

FIG. 3 is a side view of a plug terminal;

FIG. 4 is a side sectional view of the plug;

FIG. 5 is a perspective view of a socket according to an embodiment of the present invention;

FIG. 6 is a plan view of the socket;

FIG. 7 is a side view of a socket terminal;

FIG. 8 is a side sectional view of the socket;

FIG. 9 is a side sectional view illustrating an operation when the plug and the socket are fitted together; and

FIG. 10 is a side sectional view illustrating an operation when the plug and the socket are fitted together.

### DESCRIPTION OF SYMBOLS

10 first fixed housing
14 bottom face portion
16 a pair of projecting portions
20 first movable housing
23 flange
30 plural plug terminals
50 second fixed housing
54 bottom face portion
56 a pair of projection portions
60 second movable housing
64 flange
70 plural socket terminals
100 first board
200 second board

### DETAILED DESCRIPTION OF THE INVENTION

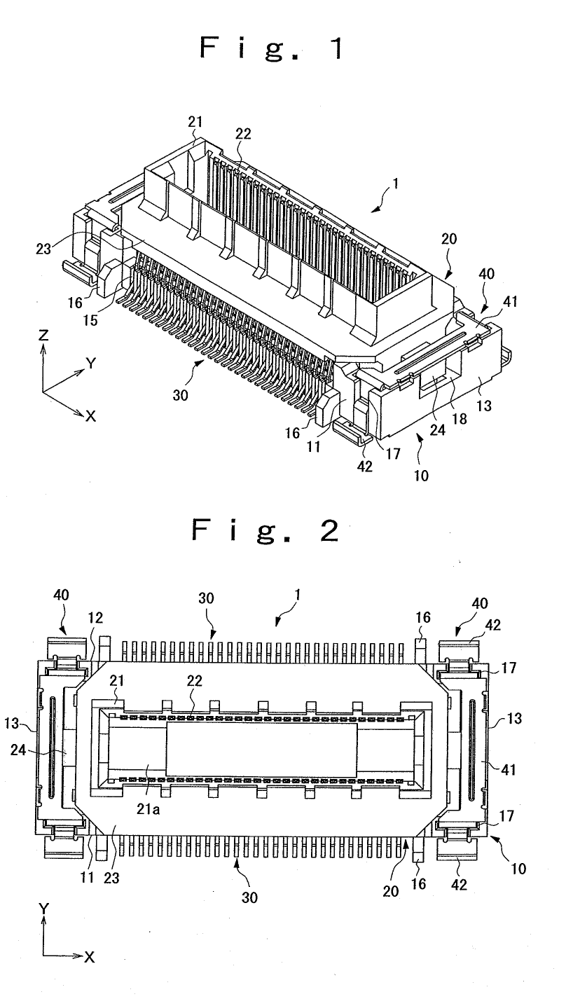

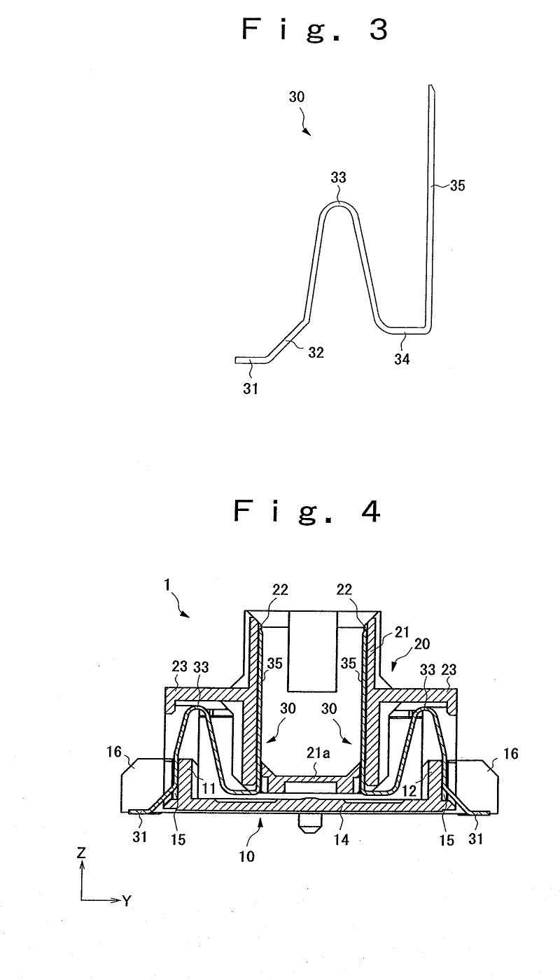

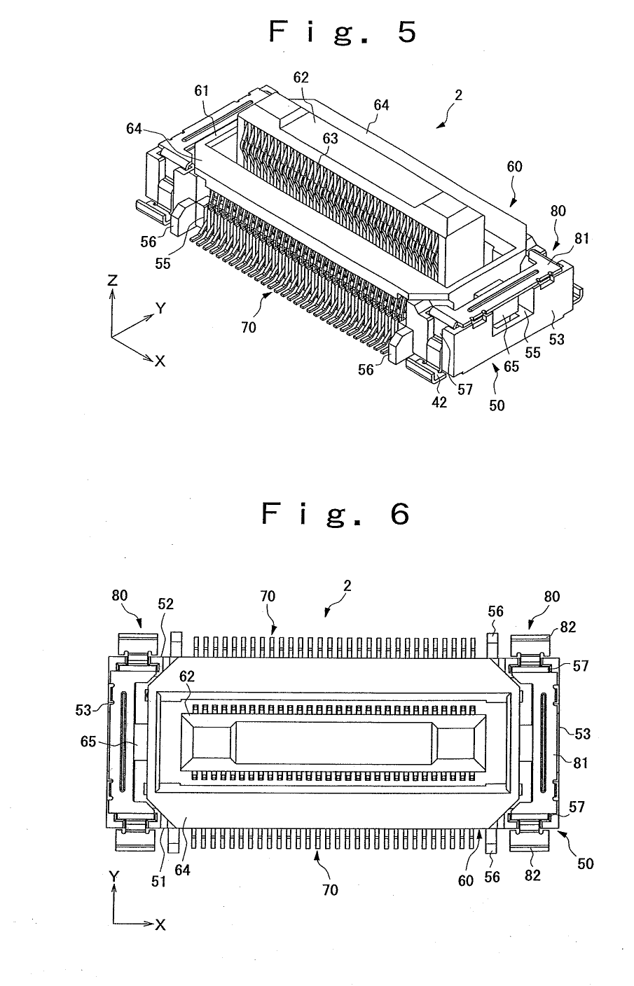

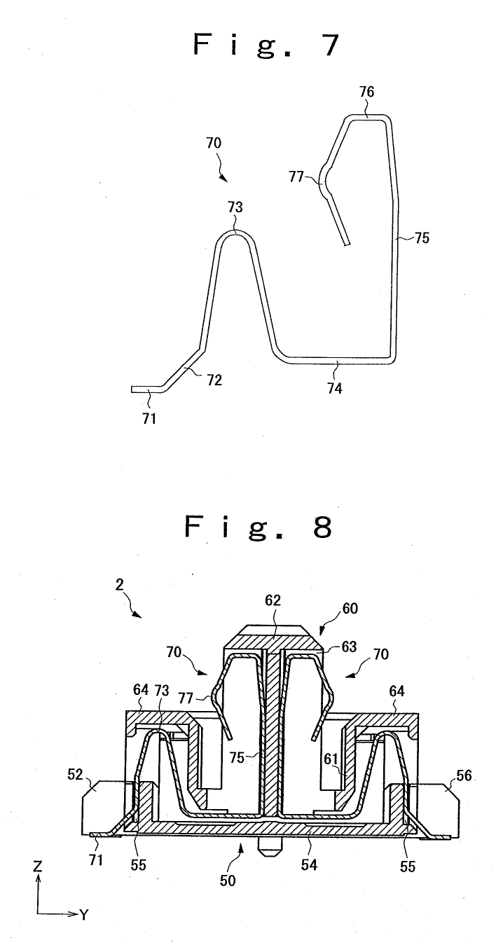

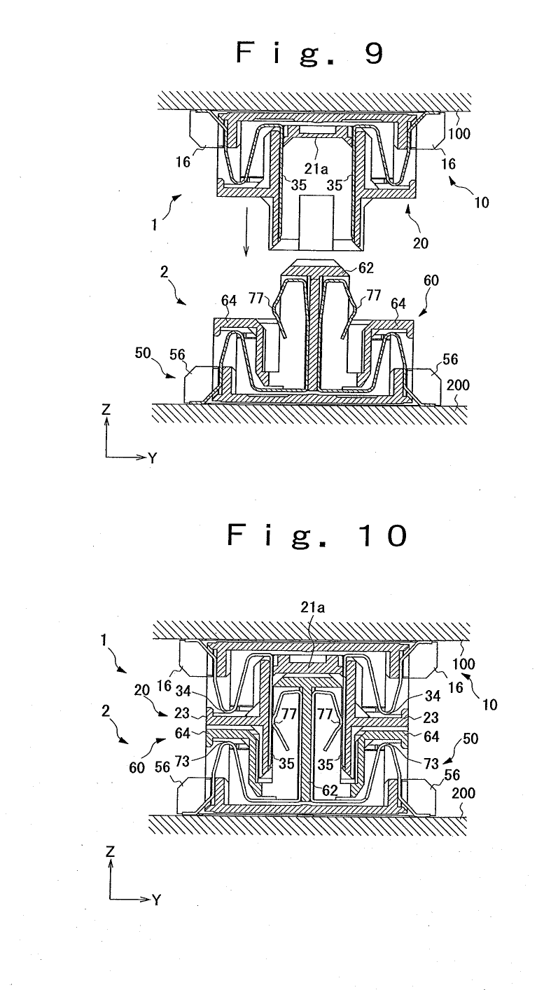

FIGS. 1 to 10 illustrate an embodiment of the present invention, in which FIG. 1 is a perspective view of a plug, FIG. 2 is a plan view of the plug, FIG. 3 is a side view of a plug terminal, FIG. 4 is a side sectional view of the plug, FIG. 5 is a perspective view of a socket, FIG. 6 is a plan view of the socket, FIG. 7 is a side view of a socket terminal, FIG. 8 is a side sectional view of the socket, and FIGS. 9 and 10 are side sectional view illustrating an operation when the plug and the socket are fitted together.

This connector comprises a plug 1 and a socket 2 and used for electrically connecting a first board 100 as one object to be connected which is connected to the plug 1 and a second board 200 as the other object to be connected which is connected to the socket 2.

At the plug 1, a first fixed housing 10 arranged on the side of the first board 100, a first movable housing 20 provided movably in a width direction (X direction in the figure), a front-and-rear direction (Y direction in the figure), and a vertical direction (Z direction in the figure) with respect to the first fixed housing 10, a plurality of plug terminals 30 having one end sides held by the first fixed housing 10 and the other end side held by the first movable housing 20 and formed so as to be elastically deformed with movement of the first movable housing 20 with respect to the first fixed housing 10, and a pair of first stopper members 40 for regulating the movement of the first movable housing 20 are provided.

The first fixed housing 10 is made of a molding of a synthetic resin in a boxed shape with an upper face opened. That is, at the first fixed housing 10, a front face portion 11, a back face portion 12, width-direction both side face portions 13 and a bottom face portion 14, in which the front face portion 11 and the back face portion 12 have a plurality of terminal holes 15 for holding the plug terminals 30, a pair of projection portions 16 projecting outward of the first fixed housing 10 at both end sides of an alignment direction (the X direction in the figure) of the terminal holes 15, and a pair of recess portions 17 formed at the upper part on both end sides in the width direction are provided, respectively. At the upper part of each side face portion 13, an engagement portion 18 for engaging the first movable housing 20 is provided, respectively.

The first movable housing 20 is made of a molding of a synthetic resin, and a box-shaped housing body 21 with an upper face opened is provided. On a width-direction side wall portion of the housing body 11, a plurality of terminal holes 22 holding each of the plug terminals 30 are formed to extend vertically and to penetrate a bottom face 21a of the housing body 21. On a front face and a rear face of the housing body 21, a flange 23 extending outward of the first movable housing 20 is provided, respectively, and a projection 24 engaged with the engagement portion 18 of the first fixed housing 10 is provided on both side faces in the width direction of the housing body 21, respectively.

The plug terminal 30 is made of an elastically deformable conductive metal plate and one row each is arranged, respectively, on both sides of the front and rear direction of the plug 1. The plug terminal 30 is, as shown in FIG. 3, formed so that a connection portion 31 connected to the first board 100 extends rearward. Also, at the plug terminal 30, a first straight portion 32 extending diagonally upward from the rear end of the connection portion 31, a bent portion 33 bent upward from the upper end of the first straight portion 32, a second straight portion 34 extending rearward from the bent portion 33, and a contact portion 35 extending upward from the second straight portion 34 are provided, and the plug terminal 30 is elastically deformed in the width direction, front and rear direction, and vertical direction with the bent portion 33 as the base point.

The stopper member 40 is formed so as to extend in the front and rear direction (Y direction in the figure) by bending work of a metal plate, and a regulating portion body 41 formed substantially in the U-shape so that one end side and the other end side are opposed to each other and a pair of board connection portion 42 extending forward or rearward, respectively, from the both ends in the front and rear direction of the regulating portion body 41 are provided. The regulating portion body 41 is formed capable of being pressed into the recess portion 17 of the first fixed housing 10, and when the regulating portion body 41 is pressed into the recess portion 17, each of the board connection portions 42 is brought into contact with the first board 100.

Here, when the plug terminal 30 is to be mounted on the first fixed housing 10, the plug terminal 30 is pressed into the terminal hole 15 from above. At this time, as shown in FIG. 4, the upper end side of the first straight portion 32 of the plug terminal 30 is held by the terminal hole 15 of the first fixed housing 10. Also, when the first movable housing 20 is pressed into the plug terminals 30 from above, the contact portion 35 of the plug terminal 30 penetrates the bottom face 21a of the housing body 21 and held in the terminal hole 22 of the first movable housing 20. In this case, the projection 24 of the first movable housing 20 is arranged in the engagement portion 18 of the first fixed housing 10, and movement of the projection 24, that is, the first movable housing 20 in the front and rear direction and downward is regulated by the engagement portion 18 within a predetermined range. When the first stopper member 40 is pressed into the recess portion 17 of the first fixed housing 10, the upper part of the engagement portion 18 is covered by the regulating portion body 41, and movement of the first movable housing 20 in the width direction and upward is regulated within a predetermined range.

In this case, the connection portion 31 of each plug terminal 30 projects in the front and rear direction of the first fixed housing 10, respectively, and each projection portion 16 projects outward from the connection portion 31 of each plug terminal 30. Also, the one end side of each plug terminal 30, that is, the first straight portion 32, the bent portion 33, and the second straight portion 34 are covered by the flange 23 of the first movable housing 20 above and by the bottom face portion 14 of the first fixed housing 10 below.

Next, construction of the socket 2 will be described. At the socket 2, a second fixed housing 50 arranged on the second board 200 side, a second movable housing 60 provided movably in the width direction (X direction in the figure), the front and rear direction (Y direction in the figure), and the vertical direction (Z direction in the figure) with respect to the second fixed housing 50, a plurality of socket terminals 70 as second terminals having one end side held by the second fixed housing 50 and the other end side held by the second movable housing 60 and formed so as to be elastically deformed with movement of the second movable housing 60 with respect to the second fixed housing 50, and a pair of second stopper members 80 regulating movement of the second movable housing 60 in the width direction, the front and rear direction, and the vertical direction are provided.

The second fixed housing 50 is formed by parts in the same shape as those of the first fixed housing 10. In this case, at the second fixed housing 50, a front face portion 51, a back face portion 52, a side face portion 53, a bottom face portion 54, each terminal hole 55, each projection portion 56, each groove portion 57, and an engagement portion 58 similar to the front face portion 11, the back face portion 12, the side face portion 13, the bottom face portion 14, each terminal hole 15, each projection portion 16, each recess portion 17 and the engagement portion 18 of the first fixed housing 10 are provided.

The second movable housing 60 is made of a molding of a synthetic resin, and a housing body 61 in the boxed shape with an upper face opened is provided. At the center on the bottom face of the housing body 61, a fitting portion 62 projecting upward and formed fittable to the housing body 21 of the first movable housing 20 is provided, and a front face and a rear face of the fitting portion 62 are formed so that a plurality of terminal holes 63 holding each socket terminal 70 penetrate the bottom face portion of the housing body 61 vertically. On the front face and the rear face of the housing body 61, a flange 64 extending outward of the second movable housing 60 is provided, respectively, and on both the side faces in the width direction of the housing body 61, a projection 65 engaged with the engagement portion 58 of the second fixed housing 50 is provided, respectively.

The socket terminal 70 is made of a conductive metal plate capable of elastic deformation, and one row each is arranged, respectively, on both sides of the socket 2 in the front and rear direction. The socket terminal 70 is, as shown in FIG. 7, formed so that a connection portion 71 connected to the second board 200 extends rearward. The socket terminal 70 has a first straight portion 72 extending diagonally upward from the rear end of the connection portion 71, a bent portion 73 bent upward from the upper end of the first straight portion 72, a second straight portion 74 extending rearward from the bent portion 73, a third straight portion 75 extending upward from the rear end of the second straight portion 74, a fourth straight portion 76 extending forward from the upper end of the third straight portion 75, and a contact portion 77 bent forward from the fourth straight portion 76 and extending downward are provided, and the plug terminal 30 is elastically deformed in the width direction, the front and rear direction, and the vertical direction with the bent portion 73 as a base point.

Each of the second stopper members 80 is formed by the parts in the same shape as the first stopper member 40, and at the second stopper member 80, a regulating portion body 81 and a pair of board connection portion 82 similar to the regulating portion body 41 of the first stopper member 40 and each board connection portion 42 are provided.

Here, in order to mount the socket terminals 70 at the second fixed housing 50, the socket terminals 70 are pressed into the terminal holes 55 from above. At this time, as shown in FIG. 8, the upper end side of the first straight portion 72 of the socket terminal 70 is held by the terminal hole 55 of the second fixed housing 50. Also, when the second movable housing 60 is pressed into the socket terminals 70 from above, the third straight portion 75 of the socket terminal 70 is held by the terminal hole 63 of the second movable housing 60. In this case, the projection 65 of the second movable housing 60 is arranged in the engagement portion 58 of the second fixed housing 50, and movement of the projection 65, that is, the second movable housing 60 in the front and rear direction and downward is regulated in a predetermined range by the engagement portion 58. When the second stopper member 80 is pressed into the groove portion 57 of the second fixed housing 50, the upper part of the engagement portion 58 is covered by the regulating portion body 81, and movement of the second movable housing 60 in the width direction and upward is regulated in a predetermined range.

In this case, the connection portion 71 of each socket terminal 70 projects in the front and rear direction of the second fixed housing 50, and each projection portion 56 projects outward from the connection portion 31 of each plug terminal 30. Also, the one end side of each socket terminal 70, that is, the first straight portion 72, the bent portion 73, and the second straight portion 74 are covered by the flange 64 of the second movable housing 60 at the upper part and by the bottom face portion 54 of the second fixed housing 50 at the lower part.

The connector constructed as above is used for electrically connecting the pair of boards 100, 200. As shown in FIG. 9, when the plug 1 connected to the first board 100 is arranged at the upper part of the socket 2 connected to the second board 200, by moving the plug 1 downward so as to fit the housing body 21 of the first movable housing 20 in the fitting portion 62 of the second movable housing 60, as shown in FIG. 10, the contact portion 77 of each socket terminal 70 is brought into contact with the contact portion 35 of the plug terminal 30. Here, when either one of the first fixed housing 10 and the second fixed housing 50 is moved in the width direction, the front and rear direction or the vertical direction with respect to the other, the terminals 30, 70 are elastically deformed, and relative displacement of the fixed housings 10, 50 is absorbed.

As mentioned above, according to the connector of this embodiment, the connector comprises the first fixed housing 10 arranged on the first board 100 side, the first movable housing 20 provided movably with respect to the first fixed housing 10, the plurality of plug terminals 30 having one end side held by the first fixed housing 10 and the other end side held by the first movable housing 20 and formed so as to be elastically deformed with movement of the first movable housing 20, the second fixed housing 50 arranged on the second board 200 side, the second movable housing 60 provided movably with respect to the second fixed housing 50 and formed fittable into the first movable housing 20, and the plurality of socket terminals 70 having one end side held by the second fixed housing 50 and the other end side held by the second movable housing 60 and formed so as to be elastically deformed with movement of the second movable housing 60 and to be brought into contact with the other end sides of the plug terminals 30, respectively, when the second movable housing 60 is fitted in the first movable housing 20, and when either one of the terminals 30, 70 is elastically deformed, the other is also elastically deformed, and a load generated in the socket terminal 70 due to the elastic deformation of the plug terminal 30 can be reduced, and connection reliability between the socket terminal 70 and the second board 200 can be improved. Also, since the terminals 30, 70 are elastically deformed, a movable range can be made wider and displacement between the first board 100 and the second board can be absorbed so as to facilitate electric connection.

Also, since the flange 23 extending in the direction (Y direction in the figure) crossing the fitting direction (Z direction in the figure) with the second movable housing 60 is provided at the first movable housing 20 so as to cover the one end side of the plug terminals 30 with the other end side held, the one end side of the plug terminals 30 is not exposed to the fitting direction and the terminals 30, 70 are not in contact with each other when the first movable housing 20 and the second movable housing 60 are not fitted with each other completely. Therefore, when the first movable housing 20 and the second movable housing 60 are not fitted with each other completely, displacement between the plug 1 and the socket 2 which might cause defective contact can be surely prevented.

Moreover, since the flange 64 extending in the direction (Y direction in the figure) crossing the fitting direction (Z direction in the figure) with the first movable housing 20 is provided at the second movable housing 60 so as to cover the one end side of the socket terminals 70 with the other end side held, the one end side of the socket terminals 70 is not exposed to the fitting direction and the terminals 30, 70 are not in contact with each other when the first movable housing 20 and the second movable housing 60 are not fitted with each other completely. Therefore, when the first movable housing 20 and the second movable housing 60 are not fitted with each other completely, displacement between the plug 1 and the socket 2 which might cause defective contact can be surely prevented.

Since the first fixed housing 10 and the second fixed housing 50 are formed by parts in the same shape, common parts can be used for the plug 1 and the socket 2. Therefore, the number of types of parts can be reduced in manufacture of the connector, which can reduce the manufacturing cost.

Moreover, since the bottom face portion 14 covering the one end side of the plug terminals 30 from the board 100 side is provided at the first fixed housing 10, the one end side of the plug terminals 30 is not brought into contact with the first board 100, and short-circuit to the first board 100 when the plug terminals 30 are elastically deformed can be surely prevented.

Also, since the bottom face portion 54 covering the one end side of the socket terminals 70 from the second board 200 side is provided at the second fixed housing 50, the one end side of the socket terminals 70 is not brought into contact with the second board 200, and short-circuit to the second board 200 when the socket terminals 70 are elastically deformed can be surely prevented.

Moreover, since the projection portion 16 projecting outward from the connection portion 31 between the plug terminals 30 and the first board 100 is provided at the first fixed housing 10, when the first movable housing 20 and the second movable housing are prying-fitted, pressing of the connection portion 31 of each plug terminal 30 onto the first board 100 side can be absorbed by the projection portion 16, and damage of the connection portion 31 of each plug terminal 30 caused by pressing can be prevented.

Also, since the projection portion 56 projecting outward from the connection portion 71 between the socket terminals 70 and the second board 200 is provided at the second fixed housing 50, when the first movable housing 20 and the second movable housing 60 are prying-fitted, pressing of the connection portion 71 of each socket terminal 70 onto the second board 200 side can be absorbed by the projection portion 56, and damage of the connection portion 71 of each socket terminal 70 caused by pressing can be prevented.

1. A connector comprising:
a first fixed housing arranged on the side of one of objects to be connected;
a first movable housing provided movably with respect to the first fixed housing;
a plurality of first terminals having one end side held by the first fixed housing and the other side held by the first movable housing and formed so as to be elastically deformed with movement of the first movable housing;
a second fixed housing arranged on the side of the other object to be connected;
a second movable housing provided movably with respect to the second fixed housing and formed so as to be fittable in the first movable housing; and
a plurality of second terminals having one end side held by the second fixed housing and the other side held by the second movable housing and formed so as to be elastically deformed with movement of the second movable housing and brought into contact with the other end side of the first terminals when the second movable housing is fitted in the first movable housing.

2. The connector according to claim 1, wherein a flange extending in a direction crossing a fitting direction with the second movable housing so as to cover one end side of the first terminals held by the first fixed housing is provided at said first movable housing.

3. The connector according to claim 2, wherein a flange extending in a direction crossing a fitting direction with the first movable housing so as to cover one end side of the second terminals held by the second fixed housing is provided at said second movable housing.

4. The connector according to claim 1, wherein a bottom face portion so as to cover one end side of the first terminals from the side of the one object to be connected is provided at said first fixed housing.

5. The connector according to claim 4, wherein a bottom face portion so as to cover one end side of the second terminals from the side of the other object to be connected is provided at said second fixed housing.

6. The connector according to claim 1, wherein a projection portion projecting outward from a connection portion between the first terminal and the one object to be connected is provided at said first fixed housing.

7. The connector according to claim 6, wherein a projection portion projecting outward from a connection portion between the second terminal and the other object to be connected is provided at said second fixed housing.

8. The connector according to claim 1 wherein said first and second fixed housings are formed by parts in the same shape.

9. The connector according to claim 2 wherein said first and second fixed housings are formed by parts in the same shape.

10. The connector according to claim 3 wherein said first and second fixed housings are formed by parts in the same shape.

11. The connector according to claim 4 wherein said first and second fixed housings are formed by parts in the same shape.

12. The connector according to claim 5 wherein said first and second fixed housings are formed by parts in the same shape.

13. The connector according to claim 6 wherein said first and second fixed housings are formed by parts in the same shape.

14. The connector according to claim 7 wherein said first and second fixed housings are formed by parts in the same shape.
